(19) United States
(12) Patent Application Publication
(10) Pub. No.: US 2016/0335683 A1
(43) Pub. Date: Nov. 17, 2016

(54) Rating System and Method

(71) Applicant: Mark Edward Roberts, Los Angeles, CA (US)

(72) Inventor: Mark Edward Roberts, Los Angeles, CA (US)

(21) Appl. No.: 15/111,749

(22) PCT Filed: Jul. 17, 2015
(86) PCT No.: PCT/US15/40992

§ 371 Date: Jul. 14, 2016

Related U.S. Application Data
(60) Provisional application No. 62/025,980, filed on Jul. 17, 2014.

(51) Int. Cl. G06Q 30/02; G06Q 50/00; G06F 17/30

(52) U.S. Cl. CPC G06Q 30/0282; G06F 17/30867; G06Q 50/01

(57) ABSTRACT

A system includes a memory comprising a first preference profile and a second preference profile, a correlation module configured to determine a correlation value between the first preference profile and the second preference profile, and a module configured to take an action as a function of the correlation value.

### PRIORITY

The present application claims priority to U.S. Provisional Patent Application Ser. No. 62/025,980 filed Jul. 17, 2014 entitled “A Socially Quantified Rating and Recommendation System and Method”. The content of the above-identified patent document is incorporated herein by reference.

### TECHNICAL FIELD

The present application relates to systems and methods for generating and providing user submitted reviews and/or recommendations.

### BACKGROUND

Some review and/or recommendation systems allow users to provide reviews of merchants, goods, service providers, entertainment venues, and the like. In some cases, the systems allow a user to assign a rating value to merchants, goods, service providers, entertainment venues, and the like. In some cases, the systems present the reviews and/or recommendations generated by a first user to a second user so that the second user can attempt to make informed decisions when evaluating and/or selecting merchants, goods, service providers, entertainment venues, and the like. However, in many cases, the personal preferences of the first user are different from the personal preferences of the second user, thereby potentially devaluing and/or negating any benefit the second user may seek from considering the reviews and/or recommendations of the first user.

### BRIEF DESCRIPTION OF THE DRAWINGS

For a more complete understanding of this disclosure, reference is now made to the following description, taken in conjunction with the accompanying drawings, in which:

FIG. 1 is a schematic view of a rating and recommendation system (RRS) in a networked environment according to the present application.

FIG. 2 is a schematic view of the RRS of FIG. 1.

FIG. 3 is a simplified representation of a general-purpose processor (e.g. electronic controller or computer) system suitable for implementing the embodiments of the disclosure.

FIG. 4 is a flowchart showing a method of operating a profile module of the RRS of FIG. 1.

FIG. 5 is a flowchart showing a method of operating a correlation module of the RRS of FIG. 1.

FIG. 6 is a flowchart showing a method of operating a sorting and display module of the RRS of FIG. 1.

FIG. 7 is a flowchart showing a method of operating a recalculation module of the RRS of FIG. 1.

FIG. 8 is a flowchart showing a method of operating a social connection module of the RRS of FIG. 1.

FIG. 9 is a flowchart showing a method of operating a group consensus module of the RRS of FIG. 1.

FIG. 10 is a flowchart showing a method of operating a group forming module of the RRS of FIG. 1.

FIG. 11 is a flowchart showing a method of operating the RRS of FIG. 1 to utilize information from a traditional rating and recommendation system (TRRS).

FIGS. 12-27 are illustrations of example user interfaces of the RRS of FIG. 1.

While the system and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION

Illustrative embodiments are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

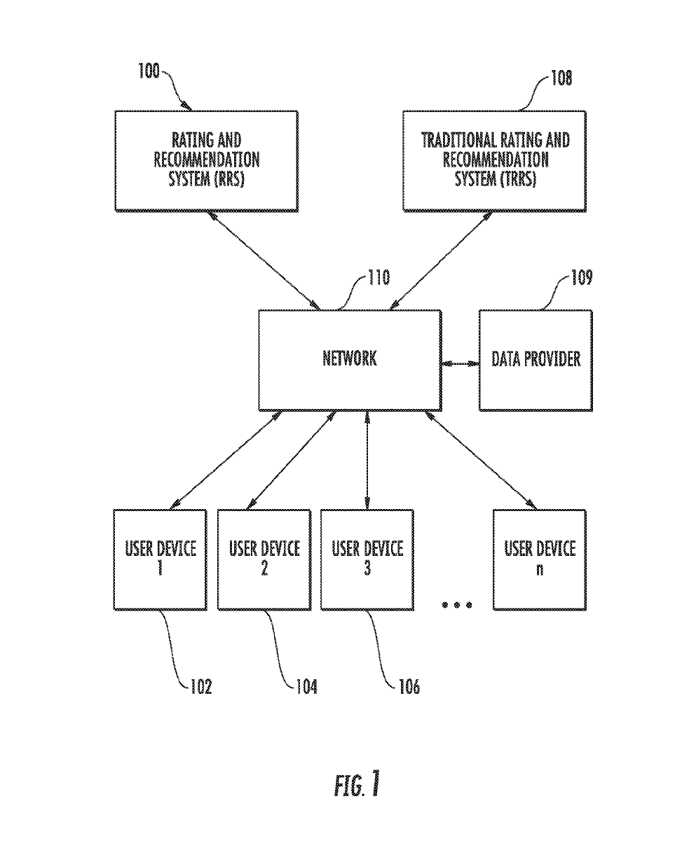

Referring to FIG. 1 in the drawings, a rating and recommendation system (RRS) 100 according to the present disclosure is shown. In some embodiments, the RRS 100 is generally comprises a computer system in bidirectional communication with one or more user devices 102, 104, 106, a traditional rating and recommendation system (TRRS) 108, and/or a data provider 109 via a network 110, such as the internet. Most generally, the RRS is configured to receive information from one or more users via the user devices 102, 104, 106 regarding user preferences and to deliver and/or display rating and/or recommendation information to users in a manner customized as a function of the user preferences received from the users. In some embodiments, the TRRS 108 can comprise a rating and recommendation system substantially similar to those of Yelp and/or other commonly known internet based systems. In some embodiments, the data provider 109 can comprise a subscription based database of merchant information, such as, but not limited to, a directory of restaurants and related information. In some cases, the related information can comprise restaurant location, hours of operation, listing of menu items, categories of cuisine, contact information, service types (i.e., whether fast food, food truck, walk-up service, etc.), and/or any other suitable information. In some embodiments, the data provider 109 can receive queries from the RRS 100 and return information that matches the query. In some cases where the information relates to restaurants, the data provider 109 may limit the number of restaurants and related information returned in response to a query to about 500 results. In some cases, the related information can comprise multiple indications of cuisine types for a single restaurant. In other words, a single restaurant can be associated with multiple cuisines.

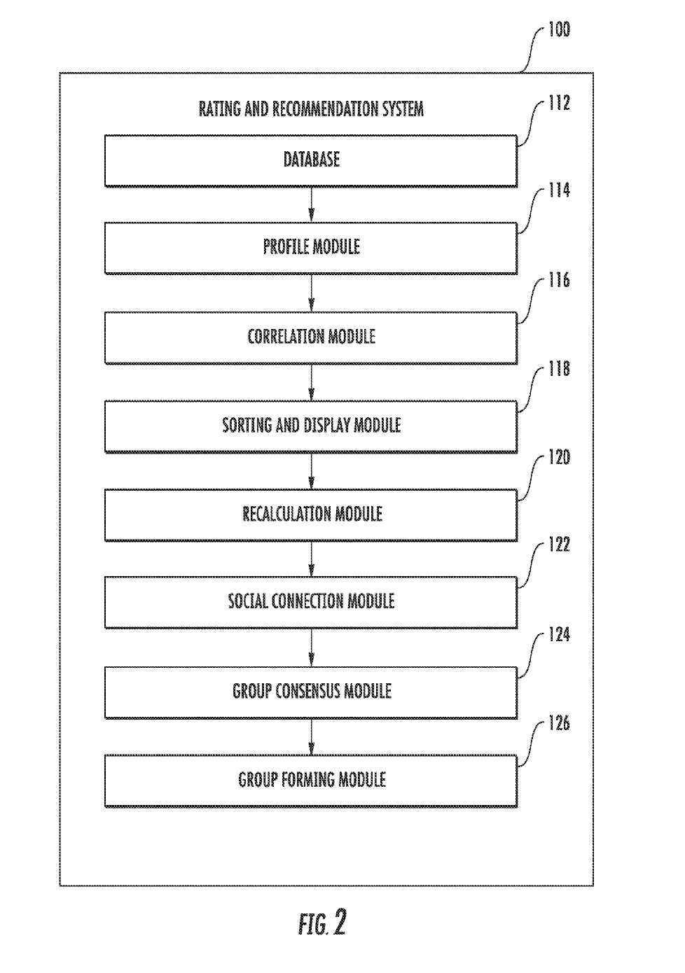

Referring now to FIG. 2 in the drawings, the RRS 100 is shown in greater detail. In some embodiments, the RRS comprises a database 112, a profile module 114, a correlation module 116, a sorting and display module 118, a recalculation module 120, a social connection module 122, a group consensus module 124, and a group forming module 126. The database 112 can comprise one or more relational and/or nonrelational databases and can be configured to receive and store user preference information regarding merchants, goods, service providers, entertainment venues, and the like. The profile module 114 can be operated to solicit user preference information that, in some embodiments, can be stored in the database 112. In some embodiments, user preference information that is specific to a particular user is referred to as a preference profile. In some embodiments, the profile module 114 can be operated to solicit and store the preference profiles in the database 112.

When provided with two preference profiles, the correlation module 116 can be operated to compare two preferences profiles and determine a degree of similarity between the compared preference profiles. The correlation module 116 can be operated to generate a correlation value between compared preference profiles. In some embodiments, a correlation value can be represented as a numerical value where higher numerical values indicate higher similarity between the compared preference profiles. The sorting and display module 118 can be operated to selectively order, sort, and/or display ratings and/or recommendations as a function of the correlation value. Similarly, the recalculation module 120 can be operated to change, augment, and/or otherwise revise a rating value as a function of the correlation value.

Further, the social connection module 122 can be operated to facilitate interaction between and/or utilization of users as a function of the correlation value associated with the users. The group consensus module 124 can be operated to synthesize and/or otherwise generate a group preference profile. The group consensus module 124 can further be operated to employ one or more of the correlation module 116, sorting and display module 118, and/or the recalculation module 120 in a manner substantially similar to that described above, but utilizing the group preference profile in place of an individual user's preference profile. In some cases, the group forming module 126 can be operated to utilize preference profiles to facilitate generation of a list of users that would likely enjoy a particular preselected group related activity or purchase.

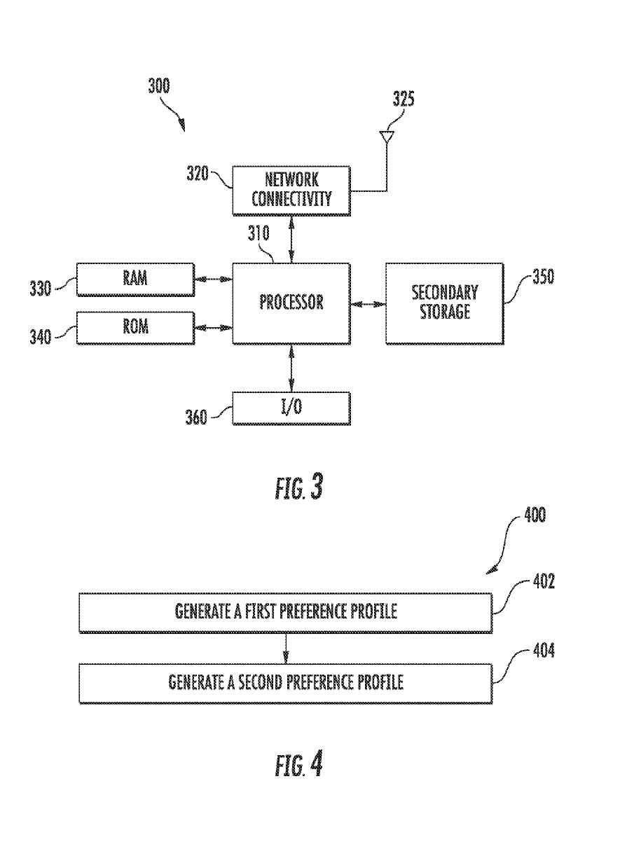

FIG. 3 illustrates a typical, general-purpose processor (e.g., electronic controller or computer) system 300 that includes a processing component 310 suitable for implementing one or more embodiments disclosed herein. In particular, the RRS 100 and/or one or more of the above-described modules of the RRS 100 may comprise one or more systems 300. In addition to the processor 310 (which may be referred to as a central processor unit or CPU), the system 300 might include network connectivity devices 320, random access memory (RAM) 330, read only memory (ROM) 340, secondary storage 350, and input/output (I/O) devices 360. In some cases, some of these components may not be present or may be combined in various combinations with one another or with other components not shown. These components might be located in a single physical entity or in more than one physical entity. Any actions described herein as being taken by the processor 310 might be taken by the processor 310 alone or by the processor 310 in conjunction with one or more components shown or not shown in the drawing. It will be appreciated that the data described herein can be stored in memory and/or in one or more databases.

The processor 310 executes instructions, codes, computer programs, or scripts that it might access from the network connectivity devices 320, RAM 330, ROM 340, or secondary storage 350 (which might include various disk-based systems such as hard disk, floppy disk, optical disk, or other drive). While only one processor 310 is shown, multiple processors may be present. Thus, while instructions may be discussed as being executed by a processor, the instructions may be executed simultaneously, serially, or otherwise by one or multiple processors. The processor 310 may be implemented as one or more CPU chips.

The network connectivity devices 320 may take the form of modems, modem banks, Ethernet devices, universal serial bus (USB) interface devices, serial interfaces, token ring devices, fiber distributed data interface (FDDI) devices, wireless local area network (WLAN) devices, radio transceiver devices such as code division multiple access (CDMA) devices, global system for mobile communications (GSM) radio transceiver devices, worldwide interoperability for microwave access (WiMAX) devices, and/or other well-known devices for connecting to networks. These network connectivity devices 320 may enable the processor 310 to communicate with the Internet or one or more telecommunications networks or other networks from which the processor 310 might receive information or to which the processor 310 might output information.

The network connectivity devices 320 might also include one or more transceiver components 325 capable of transmitting and/or receiving data wirelessly in the form of electromagnetic waves, such as radio frequency signals or microwave frequency signals. Alternatively, the data may propagate in or on the surface of electrical conductors, in coaxial cables, in waveguides, in optical media such as optical fiber, or in other media. The transceiver component 325 might include separate receiving and transmitting units or a single transceiver. Information transmitted or received by the transceiver 325 may include data that has been processed by the processor 310 or instructions that are to be executed by processor 310. Such information may be received from and outputted to a network in the form, for example, of a computer data baseband signal or signal embodied in a carrier wave. The data may be ordered according to different sequences as may be desirable for either processing or generating the data or transmitting or receiving the data. The baseband signal, the signal embedded in the carrier wave, or other types of signals currently used or hereafter developed may be referred to as the transmission medium and may be generated according to several methods well known to one skilled in the art.

The RAM 330 might be used to store volatile data and perhaps to store instructions that are executed by the processor 310. The ROM 340 is a non-volatile memory device that typically has a smaller memory capacity than the memory capacity of the secondary storage 350. ROM 340 might be used to store instructions and perhaps data that are read during execution of the instructions. Access to both RAM 330 and ROM 340 is typically faster than to secondary storage 350. The secondary storage 350 is typically comprised of one or more disk drives or tape drives and might be used for non-volatile storage of data or as an over-flow data storage device if RAM 330 is not large enough to hold all working data. Secondary storage 350 may be used to store programs or instructions that are loaded into RAM 330 when such programs are selected for execution or information is needed.

The I/O devices 360 may include liquid crystal displays (LCDs), touch screen displays, keyboards, keypads, switches, dials, mice, track balls, voice recognizers, card readers, paper tape readers, printers, video monitors, transducers, sensors, or other well-known input or output devices. Also, the transceiver 325 might be considered to be a component of the I/O devices 360 instead of or in addition to being a component of the network connectivity devices 320. Some or all of the I/O devices 360 may be substantially similar to various components disclosed herein.

Most generally, the RRS 100 can be implemented by connecting the RRS 100 with multiple users that may utilize user devices such as 102, 104, 106. The user devices can comprise smart phones, desktop computers, tablet computers, and/or any other suitable device. The RRS 100 can be implemented at least partially via a network 110 and/or utilizing internet websites, software application portals and/or stores, and/or any other suitable system for collecting, disseminating, and/or displaying RRS 100 related information. In some embodiments, the RRS 100 related information comprises dynamic data and some of the dynamic data may comprise user information such as user preference information. The RRS 100 can be utilized for a variety of purposes. While the examples below focus on utilization of the RRS 100 in the context of assisting in decision making based around dining out, restaurant selection, food choices, and other foodstuff related activity, the RRS 100 can similarly be employed to assist with choices of entertainment events, such as, but not limited to, genre of music, video, and/or film, choice of entertainment venue, and the like. Other applications of the RRS 100 include, but are not limited to, automotive, vacation destinations, hotels, books, beer, wine, and/or recipes. The RRS 100 can provide a user with improved intelligence regarding almost any user reviewed criteria and the criteria can comprise a plurality of subcriteria. For example, when utilizing the RRS 100 to assist with dining out decisions, the matter may comprise any of food type, food cost, location and/or distance, amenities, availability of live music, quality of service, quality of food, quantity of food, wait time, hours of operation, ambiance, and/or any other manner in which a user can conceive to base a review of a particular food, restaurant, or dining out related choice. For the examples below, the primary criteria utilized is the type of food, such as Italian cuisine, American cuisine, Indian cuisine, etc. With the most general functionality of the RRS 100 explained above, examples of operation of each of the modules 114, 116, 118, 120, 122, 124, and 126 are detailed below.

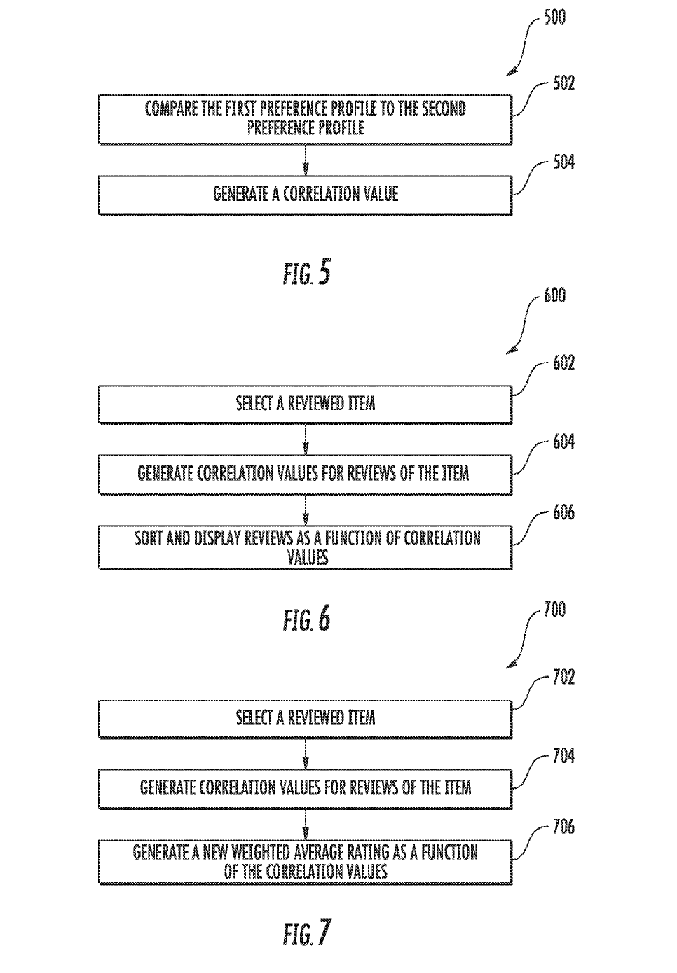

Referring now to FIG. 4 in the drawings, a flowchart of a method 400 of operating the profile module 114 of RRS 100 is shown. Method 400 can begin when the profile module 114 receives information for and generates a first preference profile. The generation of the first preference profile can be followed by the receipt of a first restaurant review from a first user who may utilize a user device, such as user device 102, to provide the information to the RRS 100. The first preference profile comprises a variety of metrics regarding the first user's preferences. For example, the RRS 100 may require the first user to provide information regarding the degree to which the first user likes or dislikes a particular type of food or cuisine. In some embodiments, users may be required to utilize virtual sliders to indicate on a scale of −5 (indicating extreme dislike) to +5 (indicating extreme liking) regarding any of the above-mentioned dining out decision related criteria. The method 400 continues at block 404 when the profile module 114 receives information for and generates a second preference profile based on substantially the same questions as the first profile and in substantially the same manner.

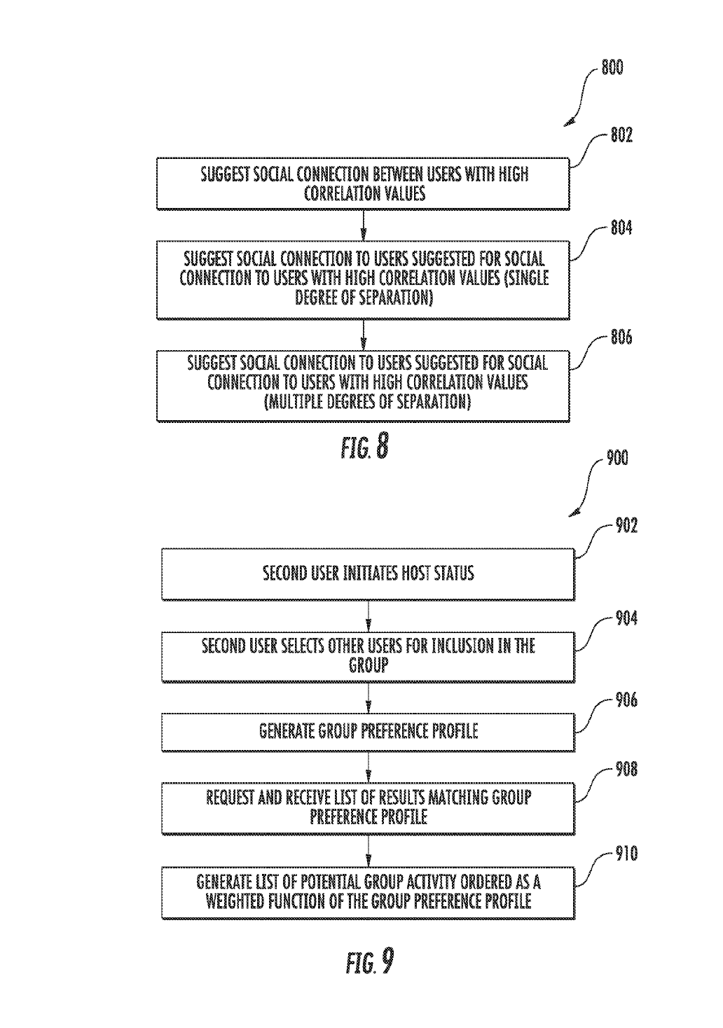

Referring now to FIG. 5 in the drawings, a flowchart of a method 500 of operating the correlation module 116 of RRS 100 is shown. In this embodiment, method 500 begins at block 502 where the correlation module 116 compares the first preference profile to the second preference profile. The method continues at block 504 where the correlation module 116 generates a correlation value between the first preference profile and the second preference profile. In some embodiments, the correlation value can be calculated around a base value of 100 to simulate a base human intelligence quota (IQ). In some embodiments, the correlation value may begin at a value of 100 and be increased when differences between first preference profile values for a criteria are very similar to second preference profile values for the same criteria. Because the differences are small, a positive number can be attributed to the beneficial nature of the users likes being similar and that positive number can be added to the base value of 100. However, where differences between first preference profile values and second preference profile values for a same criteria are medium or large, negative numbers can be attributed to the dissonance between the users likes and dislikes and the negative numbers can be subtracted from the base value of 100. In some embodiments, the correlation value is the base value of 100 plus the positive numbers attributed due to similarities minus the numbers attributed to dissimilarities.

In other words, if a first preference profile closely aligns with a second preference profile, a number greater than 100 would be the correlation value while if a first preference profile is quite different from the second preference profile, a number lower than 100 would be the correlation value. In some cases, the RRS 100 can display the correlation value to a second user associated with the second preference profile so that the second user can determine the level of usefulness a review by the first user associated with the first preference profile may be. Accordingly, a user may discount the review or opinion of the other user when the correlation value between the two users is significantly less than 100. Similarly, when the correlation value between the two users is significantly higher than 100, a user may then know to pay special attention and/or more heavily rely on the review or opinion of another user.

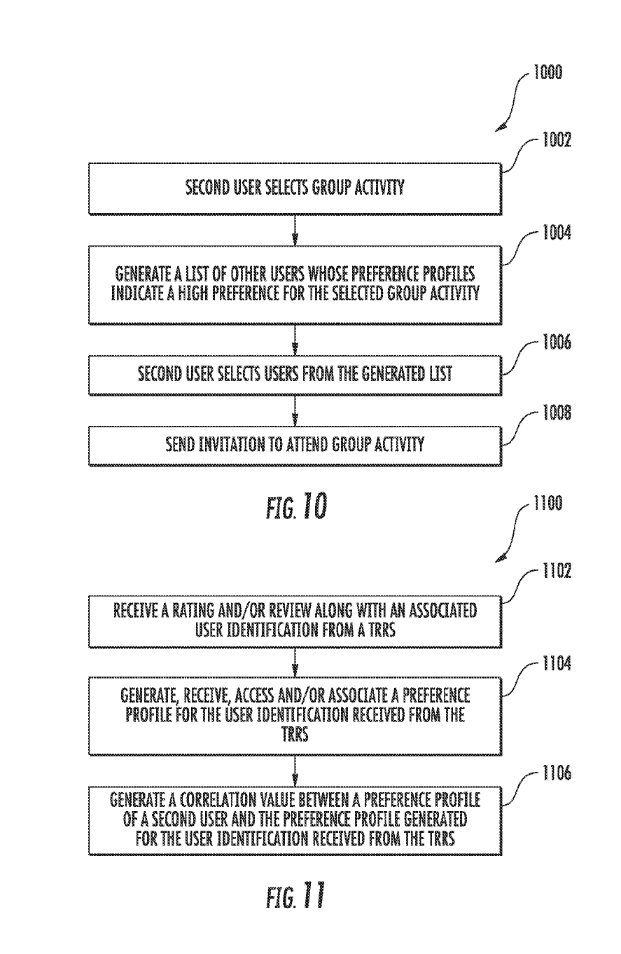

Referring now to FIG. 6 in the drawings, a flowchart of a method of operating the sorting and display module 118 of RRS 100 is shown. In this embodiment, method 600 begins at block 602 when a user such as the second user associated with the second preference profile discussed above with regard to FIGS. 4-5, navigates a web browser to select a particular reviewed item for investigation. Continuing with the previous restaurant example, the second user associated with the second preference profile can select a restaurant that the first user and other users have already reviewed and/or rated. As discussed above, reviews by users who have a low correlation value relative to the second user are presumably less useful to the second user than reviews by users who have a higher correlation value relative to the second user. Accordingly, method 600 continues at block 604 by calculating correlation values between the second user and the users who provided the reviews of the previously selected restaurant. After the correlation values are calculated, the method 600 proceeds to block 606 where the sorting and display module 118 sorts the reviews as a function of the correlation values, such as by locating reviews associated with higher correlation values higher or more immediately viewable, and then facilitating the display of the sorted list by serving the information to the user device or by displaying or otherwise presenting the sorted results.

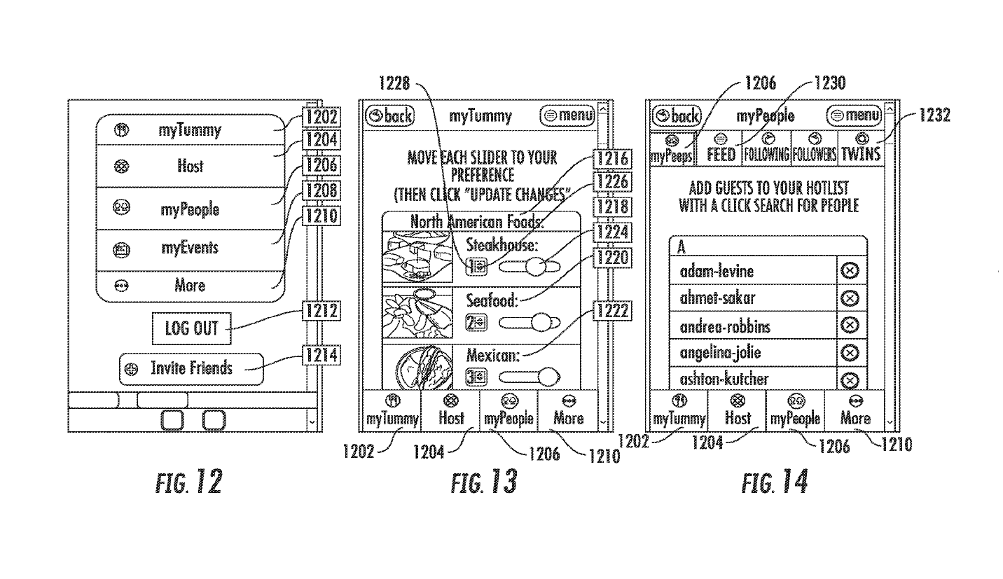

Referring now to FIG. 7 in the drawings, a flowchart of a method 700 of operating the recalculation module 120 of RRS 100 is shown. In this embodiment, method 700 begins at block 702 when a user such as the second user associated with the second preference profile discussed above with regard to FIGS. 4-6, navigates a web browser to select a particular reviewed item for investigation. Continuing with the previous restaurant example, the second user associated with the second preference profile can select a restaurant that the first user and other users have already reviewed and/or rated. As discussed above, reviews and/or ratings, such as but not limited to so-called star ratings, by users who have a low correlation value relative to the second user are presumably less useful to the second user than ratings and/or reviews by users who have a higher correlation value relative to the second user. Accordingly, method 700 continues at block 704 by calculating correlation values between the second user and the users who provided the rating, such as a star rating, of the previously selected restaurant. After the correlation values are calculated, the method 700 proceeds to block 706 where the recalculation module 120 generates a new weighted average star rating value for the selected restaurant. In this manner, the average rating or star rating for the restaurant can be corrected to more closely reflect a score that the second user may potentially be expected to give the restaurant. In some embodiments, high, medium, and low weightings (weight_H, weight_M, weight_L) can be assigned to ratings associated with highly, medium, and lowly correlated values relative to the second user. Next the recalculation module 120 can count the number of high, medium, and low correlated values (num_H, num_M, num_L). Next, the recalculation module 120 can multiply each star rating value by its associated weighting and add the resulting values together. Finally, the sum of the added values can be divided by (weight_H*num_H)+(weight_M*num_M)+(weight_L*num_L) to obtain the newly calculated average rating that is customized for the second user.

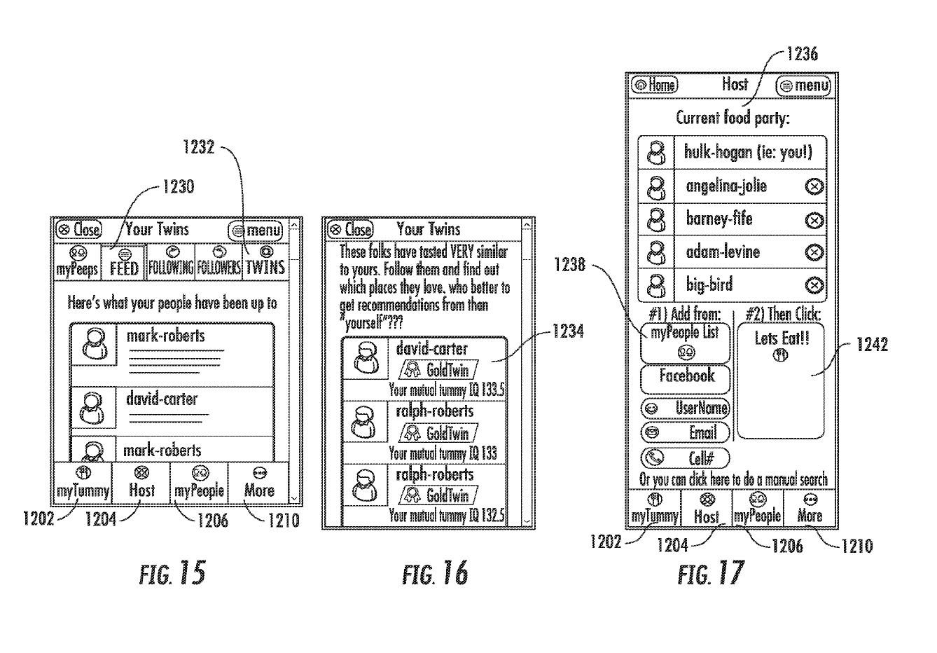

Referring now to FIG. 8 in the drawings, a flowchart of a method 800 of operating the social connection module 122 of RRS 100 is shown. The method 800 may begin at block 802 by the social connection module 122 suggesting a social connection, such as addition of a user to a list of highly correlated users, between users who are discovered to have high correlation values relative to the second user as a function of performing another method disclosed herein. In some embodiments, more social connections and/or a larger list of highly correlated users can be obtained at block 804 by checking the social lists of already listed highly correlated users for additional highly correlated users. In some cases, the RRS 100 and/or the social connection module 122 may employ the use of correlation module 116 to achieve the correlation evaluation. In some cases, after further populating the list at block 804, block 804 may be repeated to check the new listed users for additional highly correlated users. In some cases, where repetition of block 804 does not generate a desired number of users for a correlation list, the social connection module 122 may at block 806 evaluate users for potential inclusion even if the users are two or greater degrees separated from the second user. Finally, the method 800 can include randomly searching users for high correlation values relative to the second user.

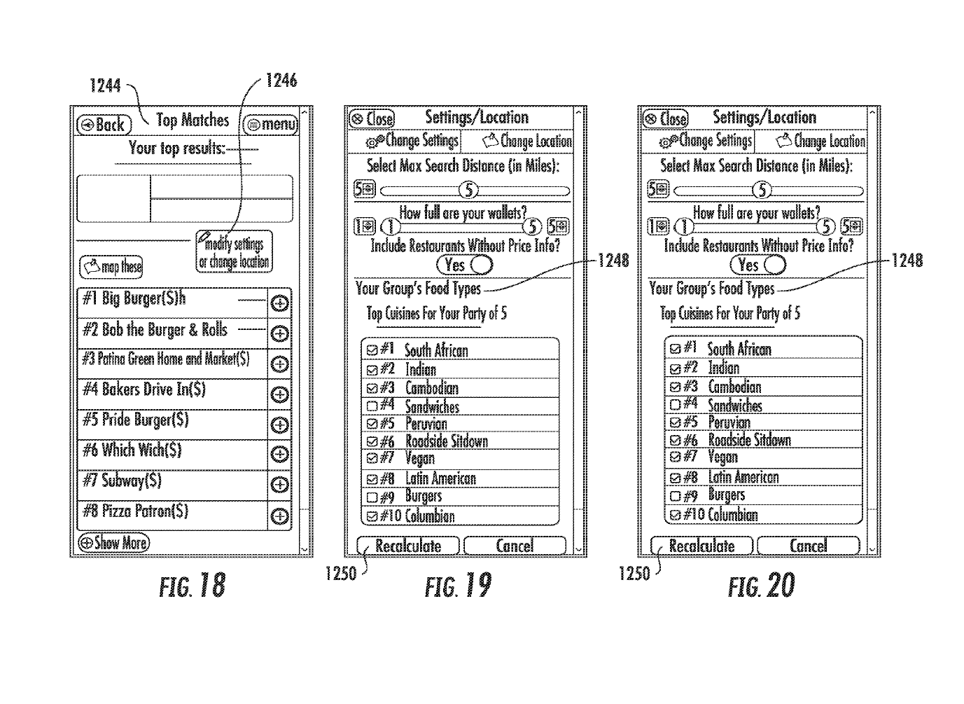

Referring now to FIG. 9 in the drawings, a flowchart of a method 900 of operating the group consensus module 124 of RRS 100 is shown. The method 900 may begin at block 902 when a user such as the second user of the previous examples decides to host or initiate a group activity. The method 900 continues at block 904 where the second user selects other users for inclusion in the group. The method 900 continues at block 906 where the group consensus module 124 combines user preference profile information, in some embodiments by adding together the raw preference profile values entered by users. The combination of the preference profile information can be referred to generally as a group preference profile. Next, at block 908, the method 900 is configured to request and receive a list of results, such as a list of restaurants from a data provider 109, that align with the group preference profile. In some cases, the received results may comprise a large number of results, such as up to about 500 restaurants. In some cases, the module 124 may select a subset of the results, such as about 100 restaurants, as a weighted function of the group preference profile so that restaurants with extremely liked cuisines are more likely to be included in the subset of the results as compared to restaurants with disliked or lesser liked cuisines.

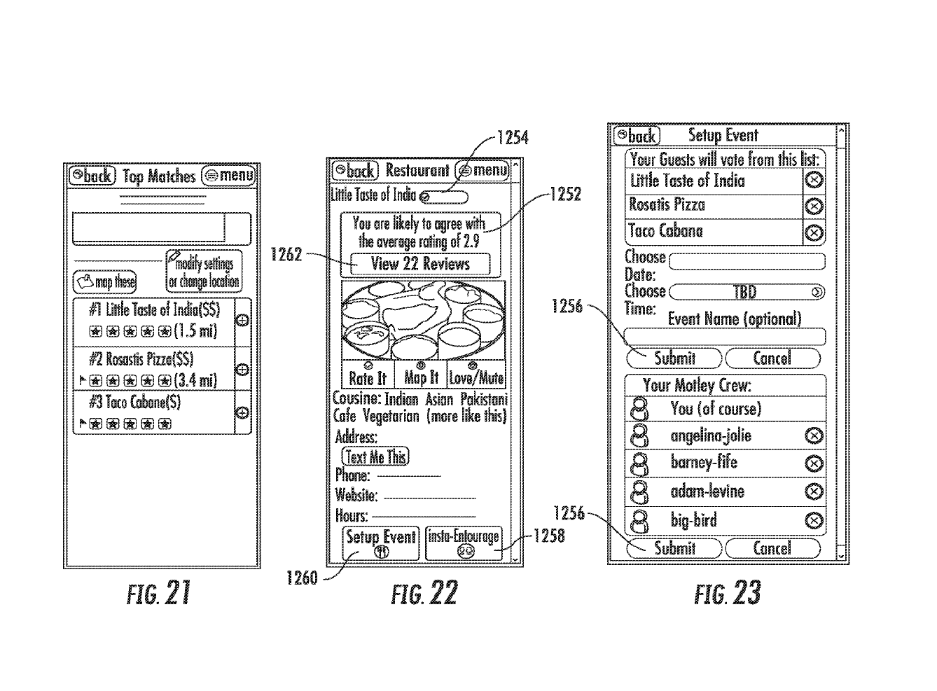

Referring now to FIG. 10 in the drawings, a flowchart of a method of operating the group forming module 126 of RRS 100 is shown. The method 1000 may begin at block 1002 when a user such as the second user of the previous examples decides to host or initiate a group activity by selecting a group activity. In some embodiments, the selecting a group activity may comprise selecting a restaurant to visit. The method may continue by the module 126 generating a list of other users whose preference profiles indicate a relatively higher preference for the selected group activity. In some cases, the selected group activity may comprise visiting a particular restaurant that offers cuisines closely aligned with the users' preference profiles. In some cases, the list of users previously generated at block 1004 includes only users likely to enjoy the cuisine of the previously selected group activity or restaurant. Next at block 1006, the second user can select some or all of the users who are included in the list generated at block 1004. Finally at block 1008, the second user can cause the module 126 to send invitations to attend the group activity to the users selected at block 1006.

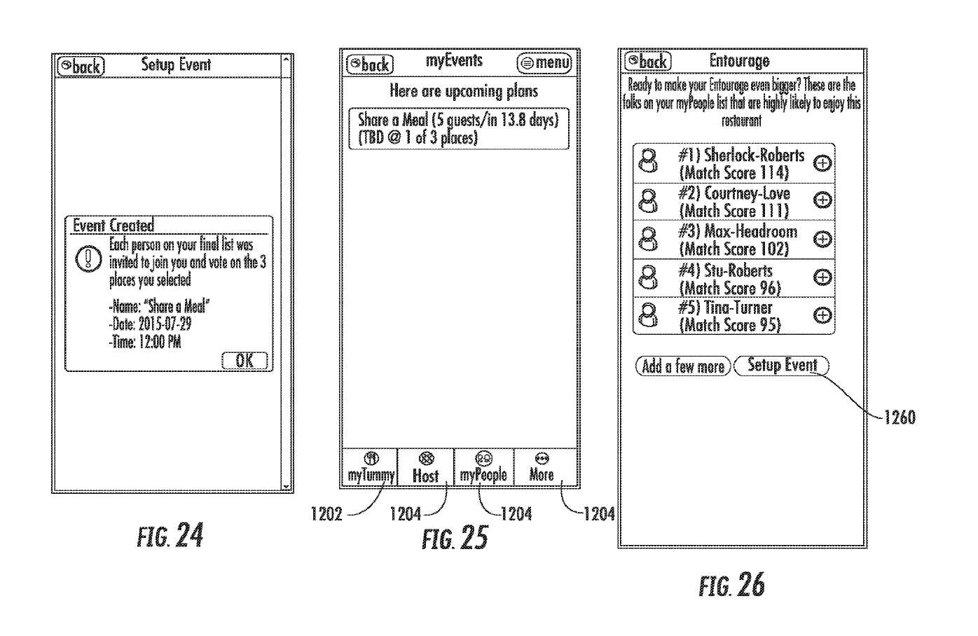

Referring now to FIG. 11 in the drawings, a flowchart of a method of operating the RRS 100 in cooperation with a TRRS 108 is shown. The method 1100 may begin at block 1102 the RRS 100 receives a rating and/or review along with an associated identified user identification from a TRRS 108. In some cases, the rating and/or review may be a restaurant star rating and the user identification may comprise a user's name and/or a login name for the TRRS 108. The method 1100 may continue at block 1104 where the RRS 100 generates, receives, accesses, and/or associates a preference profile for the TRRS user identified in the previous step. Next, at block 1106, the RRS 100 can be operated to generate a correlation value between a preference profile of a user such as the second user described above in the previous examples and the TRRS user identified in the previous steps. Accordingly, by utilizing the method 1100, the ratings and/or review content of the TRRS 108 can be made more useful to users of the RRS 100 by determining the above-described correlation values and thereafter indicating to users of the RRS 100 whether the ratings and/or reviews of the TRRS 108 are likely to be accurate or useful to them as a function of their own preference profiles.

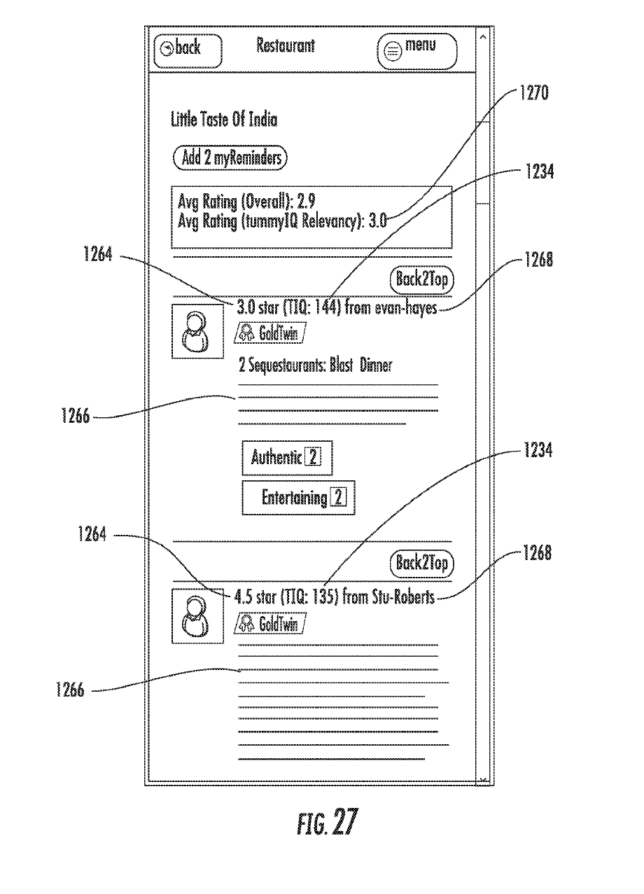

Referring now to FIGS. 12-28, embodiments of user interfaces of the RRS 100 are shown. FIG. 12 shows a home interface comprising the following virtual buttons: myTummy button 1202, Host button 1204, myPeople button 1206, myEvents button 1208, More button 1210, Log Out button 1212, and Invite Friends button 1214.

In some embodiments, pressing the myTummy button 1202 will display a user interface as shown in FIG. 13 comprising a list of preferences groups, such as the North American foods group 1216 and subgroups such as Steakhouse 1218, Seafood 1220, and Mexican 1222. Each subgroup can be associated with a slider 1224 and/or up/down arrow value incrementer 1226 configured to allow a user to input a preference value 1228. The groups and subgroups can comprise any type of potential user preference, but in this embodiment, the users preferences are related to restaurants and dining out. After a user has utilized the sliders 1224 and/or the value incrementers 1226 to generate their desired preference values 1228, the user may utilize an Update Changes virtual button to save the data and information that forms their preference profile.

In some embodiments, pressing the myPeople or myPeeps button 1206 will display a user interface as shown in FIG. 14 comprising a list of other users who are considered connected or socially connected to the user. The RRS 100 can offer functionality substantially similar to Facebook type functionality regarding following viewing activity feeds of other users. In some embodiments, pressing the Feed button 1230 can display a user interface as shown in FIG. 15. In some embodiments, the RRS 100 further comprises a Twins button 1232. In some cases, pressing the Twins button 1232 can, as shown in FIG. 16, display a user list of other users that have preference profiles relative to the user that result in high correlation values, such as correlation value 1234. While the correlation value is shown as a numerical value, the correlation values of RRS 100 can comprise any other representation and/or indication of a relative level of correlation between the preference profile of the user and another user. In some embodiments, the representation and/or indication may comprise a color, color scheme, a visible pattern, an icon, and/or the like.

In some embodiments, pressing the Host button 1204 can display a user interface such as that shown in FIG. 17. The user interface can display a list of users that are currently included for consideration in selection of a restaurant for the group to visit. The user can select the myPeople list button 1238 to be shown a list of their current social connections or connected users and be allowed to add any of the users of that list to the current food party list 1236. Alternatively, the user can select the Facebook button 1240 to be shown a list of their current Facebook friends or otherwise Facebook based connected users and be allowed to add any of the users of that list to the current food party list 1236. Since each user in the current food party list 1236 has their own preference profile, in some embodiments, the preference profiles of each of the users who may dine together are taken into consideration. In some embodiments, the preference profiles of the users in the current food party list 1236 can be combined, in some embodiment by summing the values, to create a group preference profile using preference values. Next, the RRS 100 can query the data provider 109 for a large list of restaurants that include cuisines most favored by the users of the current food party list 1236. Since the restaurant information returned to the RRS 100 may comprise a large number of restaurants and since each restaurant may be associated with a plurality of cuisines and/or other categories, the RRS 100 can determine a demand level for each of the restaurants by scoring the restaurants so that restaurants with the most raw preference profile value overlap and/or correlation with the group preference profile are selected to populate a smaller list of restaurants ordered based on the group preference as a whole instead of based on a single user of the group.

As a simplified example of how the smaller list of restaurants may be ordered, consider the following scenario where a list of restaurants is returned to RRS 100 by data provider 109 as comprising Restaurants 1, 2, and 3 where Restaurant 1 serves 50% American cuisine, 50% Italian cuisine, and 0% Indian cuisine, Restaurant 2 serves 0% American cuisine, 50% Italian cuisine, and 50% Indian cuisine, and Restaurant 3 serves 50% American cuisine, 0% Italian cuisine, and 50% Indian cuisine. Further, consider that there is a current food party list that includes Users 1, 2, and 3 where User 1 has indicated preference values of +1 for American cuisine, +4 for Italian cuisine, and −2 for Indian cuisine, User 2 has indicated preference values of +2 for American cuisine, +1 for Italian cuisine, and +5 for Indian cuisine, and User 3 has indicated preference values of −2 for American cuisine, −1 for Italian cuisine, and +3 for Indian cuisine. Collectively, the group preference can be additively determined as +1 for American cuisine, +4 for Italian cuisine, and +6 for Indian cuisine. If the restaurants were to be listed in order of only User 1's preference, User 2's preference, or User 3's preference, the result would differ from the group preference profile based order of (in order of decreasing preference) Restaurant 3, Restaurant 1, Restaurant 2.

After having populated the current food party list 1236 as desired, a user can select the Lets Eat button 1242. After pressing the Lets Eat button 1242, the user may be presented with a user interface as shown in FIG. 18 which displays a Top Matches list 1244 that lists the restaurants in order as a function of the group preference profile as described above. If the user does not like the contents of the Top Matches list 1244, the user can select the Modify Settings or Change Location button 1246. After selecting the button 1246, the RRS 100 can present a user interface as shown in FIG. 19 that comprises a Your Group's Food Types list 1248 comprising a listing of the cuisines and/or other characteristics collectively desired by the group. In some cases, the user can deselect one or more of the food types or other characteristics. FIG. 20 shows an example where a user has deselected both the fourth and ninth ranking cuisines and/or characteristics, namely, sandwiches and burgers. After deselecting the undesired characteristics, the user can select a Recalculate button 1250. After selecting the Recalculate button 1250, the user can be presented, as shown in FIG. 21, with a revised list of restaurants in order of best matching the group preference profile. A user can select a listed restaurant and the RRS 100 can present a view of the restaurant information as shown in FIG. 22. A user is further presented with a correlation indication 1252 which displays or otherwise presents information regarding a degree to which the user may concur with a rating or recommendation (or average rating) of the restaurant as previously made by other users. The user may select the Add 2 Ballot button 1254 to add the displayed restaurant to a ballot for later review and voting by the users of the current food party list 1236. After populating the above-mentioned ballot, the RRS 100 may display a Setup Event interface such as that shown in FIG. 23 where the user may remove restaurants from the ballot, choose a date and time, name the event, and remove users from the group list. After entering the desired information, the user may select a Submit button 1256 and in return be presented with an Event Created notification such as that shown in FIG. 24. The event may be reviewed and/or displayed as shown in FIG. 25 by selecting the myEvents button 1208 of the interface of FIG. 12.

Referring back to FIG. 22, in some embodiments, a view of a restaurant can generally be accompanied by an Insta-Entourage button 1258. A user can select the Insta-Entourage button 1258 to display a user interface such as that shown in FIG. 26. The user interface of FIG. 26 displays a list of users to which the user is connected (i.e. are otherwise included in the user's myPeople list) and whose preference profile indicates a high likelihood of liking the restaurant previously viewed in the interface of FIG. 22. As such, the user can easily generate a list of users who are likely to enjoy dining at the restaurant previously viewed in the user interface of FIG. 22. After the user has generated a desired list of users, the user can select a Setup Event button 1260. After selecting the Setup Event button 1260, the user can be presented with a user interface substantially similar to the user interface of FIG. 23 to allow the user to remove restaurants from a ballot, choose a date and time, name the event, and remove users from the group list. After entering the desired information, the user may select a Submit button 1256 and in return be presented with an Event Created notification such as that shown in FIG. 24.

Referring back to FIG. 22, in some embodiments, a view of a restaurant can generally be accompanied by a View Ratings button 1262. A user can select the View Ratings button 1262 to display a user interface such as that shown in FIG. 27. The user interface of FIG. 27 displays a list of star ratings 1264 and associated reviews 1266 (collectively referred to as feedback) submitted by users 1268. The users 1268 and their associated star ratings 1264 and reviews 1266 are listed in order of descending correlation values 1234. In this way, the a user viewing the user interface of FIG. 27 is presented with the most relevant feedback from other users about the restaurant first with less relevant feedback about the restaurant being provide lower and/or later in the list of feedback. In some embodiments, a correlation relevancy value 1270 can be provided. In some embodiments, the correlation relevancy value 1270 can be provided as an output and/or function of an output of the recalculation module 120.

As used herein, the term “feedback” is intended to mean a rating, review, commentary, and/or any other suitable information about the goods, services, experience, impression, and/or any other suitable metric and/or judgement regarding a merchant, good, event, location, service, product, process, etc. In other words, feedback can be any opinion or fact information generated by a user about a merchant, good, event, location, service, product, process, etc. In some of the examples above, the feedback comprises ratings, star ratings, reviews, and/or commentary about restaurants and/or cuisines. It will be appreciated that the content of the user interfaces disclosed may be generated, presented, calculated, and/or otherwise handled by one or more of the RRS 100 modules and/or more generally by the RRS 100 as a whole.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A system, comprising:
a memory comprising a first preference profile and a second preference profile;
a correlation module configured to determine a correlation value between the first preference profile and the second preference profile; and
a module configured to take an action as a function of the correlation value.

2. The system of claim 1, wherein the taking the action comprises displaying the correlation value.

3. The system of claim 1, wherein the taking the action comprises sorting a plurality of feedbacks as a function of the correlation value.

4. The system of claim 1, wherein the taking the action comprises calculating a rating value as a function of the correlation value.

5. The system of claim 1, wherein the taking the action comprises determining a social connection recommendation as a function of the correlation value.

6. The system of claim 1, wherein at least one of the first preference profile and the second preference profile comprise a group preference profile.

7. The system of claim 1, further comprising:
a module configured to receive a group activity selection from a first user associated with the first preference profile and determine a correlation between the second preference profile and the group activity selection.

8. A method, comprising:
generating a first preference profile and a second preference profile;
comparing the first preference profile and the second preference profile;
taking an action as a function of the comparison between the first preference profile and the second preference profile.

9. The method of claim 8, wherein the taking the action comprises displaying the correlation value.

10. The method of claim 8, wherein the taking the action comprises sorting feedback as a function of the correlation value.

11. The method of claim 8, wherein the taking the action comprises calculating a rating value as a function of the correlation value.

12. The method of claim 8, wherein the taking the action comprises determining a social connection recommendation as a function of the correlation value.

13. The method of claim 8, wherein at least one of the first preference profile and the second preference profile comprise a group preference profile.

14. The system of claim 8, further comprising:
receiving a group activity selection from a first user associated with the first preference profile; and
determining a correlation between the second preference profile and the group activity selection.

15. A system, comprising:
a memory comprising a first preference profile associated with a first user and a second preference profile associated with a second user;
a module configured to receive feedback information associated with the second user from a traditional rating and review system (TRRS).

16. The system of claim 15, further comprising:
a correlation module configured to determine a correlation value between the first preference profile and the second preference profile and configured to display the correlation value.

17. The system of claim 15, further comprising:
a correlation module configured to determine a correlation value between the first preference profile and the second preference profile and configured to sort a plurality of feedbacks as a function of the correlation value.

18. The system of claim 15, further comprising:
a correlation module configured to determine a correlation value between the first preference profile and the second preference profile and configured to calculate a rating value as a function of the correlation value.

19. The system of claim 15, further comprising:
a correlation module configured to determine a correlation value between the first preference profile and the second preference profile and configured to determine a social connection recommendation as a function of the correlation value.

20. The system of claim 15, wherein the module is configured to communicate with the TRRS via a network.
